(19) United States
(12) Patent Application Publication
(10) Pub. No.: US 2008/0191845 A1
(43) Pub. Date: Aug. 14, 2008

(54) Location-Based Power Management in RFID Applications

(75) Inventor: Martin STRZELCZYK, New Market, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 12/029,452

(22) Filed: Feb. 11, 2008

Related U.S. Application Data
(60) Provisional application No. 60/900,319, filed on Feb. 9, 2007.

(51) Int. Cl. H04Q 5/22

(52) U.S. Cl. 340/10.5

(57) ABSTRACT

A method of managing power consumption of a radio frequency identification (RFID) reader is provided. The method includes determining a location of a mobile RFID reader, retrieving scanning characteristics for location, updating scanning settings of the mobile RFID reader.

### CROSS REFERENCE TO RELATED APPLICATIONS

This application claims the benefit of U.S. Provisional Appl. No. 60/900,319, filed Feb. 9, 2007, which is incorporated by reference herein in its entirety.

### FIELD OF THE INVENTION

The present invention relates to radio frequency identification (RFID) technology.

### BACKGROUND

Radio frequency identification (RFID) tags are electronic devices that may be affixed to items whose presence is to be detected and/or monitored. The presence of an RFID tag, and therefore the presence of the item to which the tag is affixed, may be checked and monitored wirelessly by devices known as “readers.” With the maturation of RFID technology, efficient communication between tags and readers has become a key enabler in supply chain management, especially in manufacturing, shipping, and retail industries, as well as in building security installations, healthcare facilities, libraries, airports, warehouses etc.

In many applications, RFID technology is used to monitor a large population of items. As the number of tags in a tag population and the area they span increases, reading each tag becomes an increasingly power intensive process. This increasing demand on power results in more complicated circuitry at the reader and/or the tag, often leading to problems during operation. Additionally, the increased demand for power results in the need for a larger battery for the RFID reader, which is undesirable for mobile, battery powered applications.

Thus, what are needed are systems and methods for conserving power during scanning operations within a mobile reader installation.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an environment where RFID readers communicate with an exemplary population of RFID tags.

FIG. 2 shows a block diagram of receiver and transmitter portions of a RFID reader.

FIG. 3 shows a block diagram of an example RFID tag.

FIGS. 4 and 5 show systems for monitoring the presence of items in an RFID environment, according to embodiments of the present invention.

FIG. 6 shows a flowchart a method for reducing power consumption in readers through application of location information, according to embodiments of the present invention.

FIG. 7 is a block diagram of an exemplary computer system useful for implementing the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner. Likewise, particular bit values of “0” or “1” (and representative voltage values) are used in illustrative examples provided herein to represent data for purposes of illustration only. Data described herein can be represented by either bit value (and by alternative voltage values), and embodiments described herein can be configured to operate on either bit value (and any representative voltage value), as would be understood by persons skilled in the relevant art(s).

### Example RFID System Embodiment

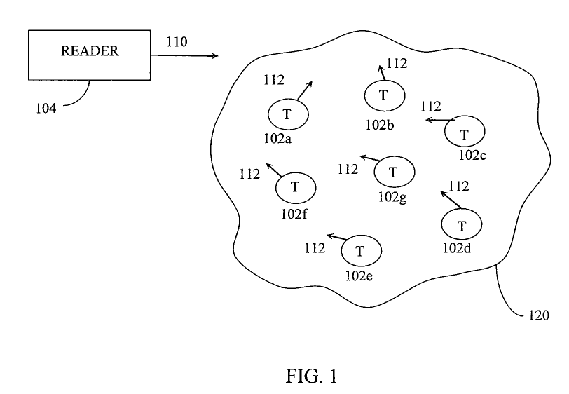

Before describing embodiments of the present invention in detail, it is helpful to describe an example RFID communications environment in which the invention may be implemented. FIG. 1 illustrates an environment 100 where a RFID tag reader 104 (also referred to as an “interrogator”) communicates with an exemplary population 120 of RFID tags 102. As shown in FIG. 1, the population 120 of tags includes seven tags 102a-102g. A population 120 may include any number of tags 102.

Environment 100 includes one or more readers 104. A reader 104 may be requested by an external application to address the population of tags 120. Alternatively, reader 104 may have internal logic that initiates communication, or may have a trigger mechanism that an operator of reader 104 uses to initiate communication.

As shown in FIG. 1, reader 104 transmits an interrogation signal 110 having a carrier frequency to the population of tags 120. Reader 104 operates in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104 receive and obtain data from response signals 112, such as an identification number of the responding tag 102. In the embodiments described herein, a reader may be capable of communicating with tags 102 according to any suitable communication protocol, including binary traversal protocols, slotted aloha protocols, Class 0, Class 1, EPC Gen 2, any others mentioned elsewhere herein, and future communication protocols.

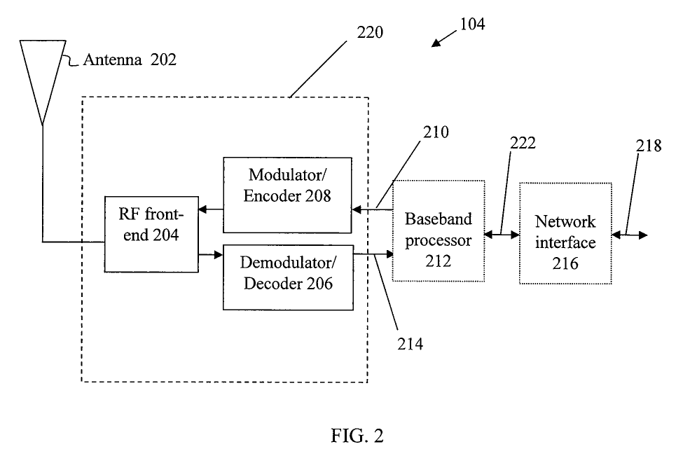

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch antenna type. For description of an example antenna suitable for reader 104, refer to U.S. Ser. No. 11/265,143, filed Nov. 3, 2005, titled “Low Return Loss Rugged RFID Antenna,” now pending, which is incorporated by reference herein in its entirety.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including a IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, modulates the encoded signal, and outputs the modulated encoded interrogation signal to RF front-end 204. For example, pulse-interval encoding (PIE) may be used in a Gen 2 embodiment. Furthermore, double sideband amplitude shift keying (DSB-ASK), single sideband amplitude shift keying (SSB-ASK), or phase-reversal amplitude shift keying (PR-ASK) modulation schemes may be used in a Gen 2 embodiment. Note that in an embodiment, baseband processor 212 may alternatively perform the encoding function of modulator/encoder 208.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FM0 or Miller encoding formats in an EPC Gen 2 embodiment. Demodulator/decoder 206 outputs decoded data signal 214. Note that in an embodiment, baseband processor 212 may alternatively perform the decoding function of demodulator/decoder 206.

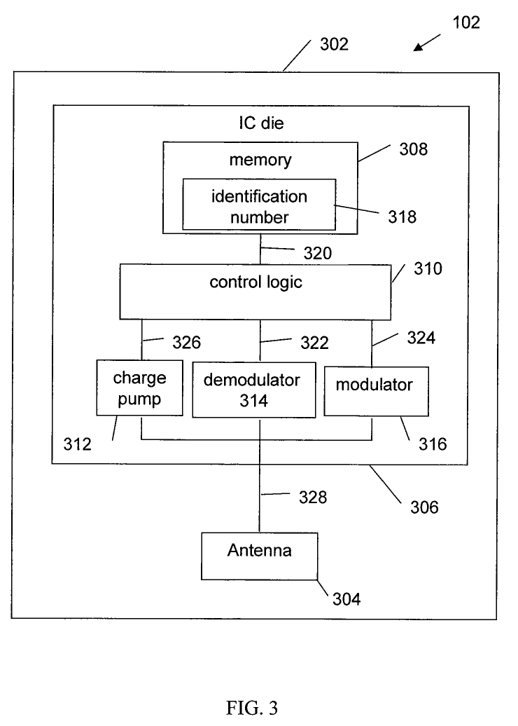

The present invention is applicable to any type of RFID tag. FIG. 3 shows a plan view of an example radio frequency identification (RFID) tag 102. Tag 102 includes a substrate 302, an antenna 304, and an integrated circuit (IC) 306. Antenna 304 is formed on a surface of substrate 302. Antenna 304 may include any number of one, two, or more separate antennas of any suitable antenna type, including dipole, loop, slot, or patch antenna type. IC 306 includes one or more integrated circuit chips/dies, and can include other electronic circuitry. IC 306 is attached to substrate 302, and is coupled to antenna 304. IC 306 may be attached to substrate 302 in a recessed and/or non-recessed location.

IC 306 controls operation of tag 102, and transmits signals to, and receives signals from RFID readers using antenna 304. In the example embodiment of FIG. 3, IC 306 includes a memory 308, a control logic 310, a charge pump 312, a demodulator 314, and a modulator 316. An input of charge pump 312, an input of demodulator 314, and an output of modulator 316 are coupled to antenna 304 by antenna signal 328. Note that in the present disclosure, the terms “lead” and “signal” may be used interchangeably to denote the connection between elements or the signal flowing on that connection.

Memory 308 is typically a non-volatile memory, but can alternatively be a volatile memory, such as a SRAM. Memory 308 stores data, including an identification number 318. Identification number 318 typically is a unique identifier (at least in a local environment) for tag 102. For instance, when tag 102 is interrogated by a reader (e.g., receives interrogation signal 110 shown in FIG. 1), tag 102 may respond with identification number 318 to identify itself. Identification number 318 may be used by a computer system to associate tag 102 with its particular associated object/item.

Demodulator 314 is coupled to antenna 304 by antenna signal 328. Demodulator 314 demodulates a radio frequency communication signal (e.g., interrogation signal 110) on antenna signal 328 received from a reader by antenna 304. Control logic 310 receives demodulated data of the radio frequency communication signal from demodulator 314 on input signal 322. Control logic 310 controls the operation of RFID tag 102, based on internal logic, the information received from demodulator 314, and the contents of memory 308. For example, control logic 310 accesses memory 308 via a bus 320 to determine whether tag 102 is to transmit a logical “1” or a logical “0” (of identification number 318) in response to a reader interrogation. Control logic 310 outputs data to be transmitted to a reader (e.g., response signal 112) onto an output signal 324. Control logic 310 may include software, firmware, and/or hardware, or any combination thereof. For example, control logic 310 may include digital circuitry, such as logic gates, and may be configured as a state machine in an embodiment.

Modulator 316 is coupled to antenna 304 by antenna signal 328, and receives output signal 324 from control logic 310. Modulator 316 modulates data of output signal 324 (e.g., one or more bits of identification number 318) onto a radio frequency signal (e.g., a carrier signal transmitted by reader 104) received via antenna 304. The modulated radio frequency signal is response signal 112, which is received by reader 104. In an embodiment, modulator 316 includes a switch, such as a single pole, single throw (SPST) switch. The switch changes the return loss of antenna 304. The return loss may be changed in any of a variety of ways. For example, the RF voltage at antenna 304 when the switch is in an “on” state may be set lower than the RF voltage at antenna 304 when the switch is in an “off” state by a predetermined percentage (e.g., 30 percent). This may be accomplished by any of a variety of methods known to persons skilled in the relevant art(s).

Modulator 316 and demodulator 314 may be referred to collectively as a “transceiver” of tag 102.

Charge pump 312 is coupled to antenna 304 by antenna signal 328. Charge pump 312 receives a radio frequency communication signal (e.g., a carrier signal transmitted by reader 104) from antenna 304, and generates a direct current (DC) voltage level that is output on a tag power signal 326. Tag power signal 326 is used to power circuits of IC die 306, including control logic 320.

In an embodiment, charge pump 312 rectifies the radio frequency communication signal of antenna signal 328 to create a voltage level. Furthermore, charge pump 312 increases the created voltage level to a level sufficient to power circuits of IC die 306. Charge pump 312 may also include a regulator to stabilize the voltage of tag power signal 326. Charge pump 312 may be configured in any suitable way known to persons skilled in the relevant art(s). For description of an example charge pump applicable to tag 102, refer to U.S. Pat. No. 6,734,797, titled “Identification Tag Utilizing Charge Pumps for Voltage Supply Generation and Data Recovery,” which is incorporated by reference herein in its entirety. Alternative circuits for generating power in a tag are also applicable to embodiments of the present invention.

It will be recognized by persons skilled in the relevant art(s) that tag 102 may include any number of modulators, demodulators, charge pumps, and antennas. Tag 102 may additionally include further elements, including an impedance matching network and/or other circuitry. Embodiments of the present invention may be implemented in tag 102, and in other types of tags.

Embodiments described herein are applicable to all forms of tags, including tag “inlays” and “labels.” A “tag inlay” or “inlay” is defined as an assembled RFID device that generally includes an integrated circuit chip (and/or other electronic circuit) and antenna formed on a substrate, and is configured to respond to interrogations. A “tag label” or “label” is generally defined as an inlay that has been attached to a pressure sensitive adhesive (PSA) construction, or has been laminated, and cut and stacked for application. Another example form of a “tag” is a tag inlay that has been attached to another surface, or between surfaces, such as paper, cardboard, etc., for attachment to an object to be tracked, such as an article of clothing, etc.

Example embodiments of the present invention are described in further detail below. Such embodiments may be implemented in the environments, readers, and tags described above, and/or in alternative environments and alternative RFID devices.

### Example Embodiments

Mobile RFID readers are sometimes operated in a continuous scanning mode in which the mobile reader continuously performs high power scanning. Such high power scanning is typically undesirable in mobile, battery powered applications. In battery powered applications, power saved may result in a longer battery life. It is therefore beneficial to limit the intervals during which this high degree of scanning occurs. This limitation may be accomplished by confining the area in which constant high power scanning occurs. For example, the duty cycle (percentage of time spend scanning) and/or the output power while scanning can be lowered for specific locations.

Methods, systems, and apparatuses for location-based power conservation in an RFID reader are presented. In an embodiment, a mobile reader uses location information to adjust its scanning characteristics.

Scanning may be defined as interrogating all or a portion of all tags in a given location. A location may be scanned multiple times during a pass through of that location. Scanning characteristics of a location may determine the scanning setting used by a reader for one or a series of scans of the location. Power consumed for a given period of scanning is determined at least by the percentage of time scanning (i.e. the duty cycle) and/or the output power during scanning. The frequency of scanning as described herein refers to a number of scans in a time period.

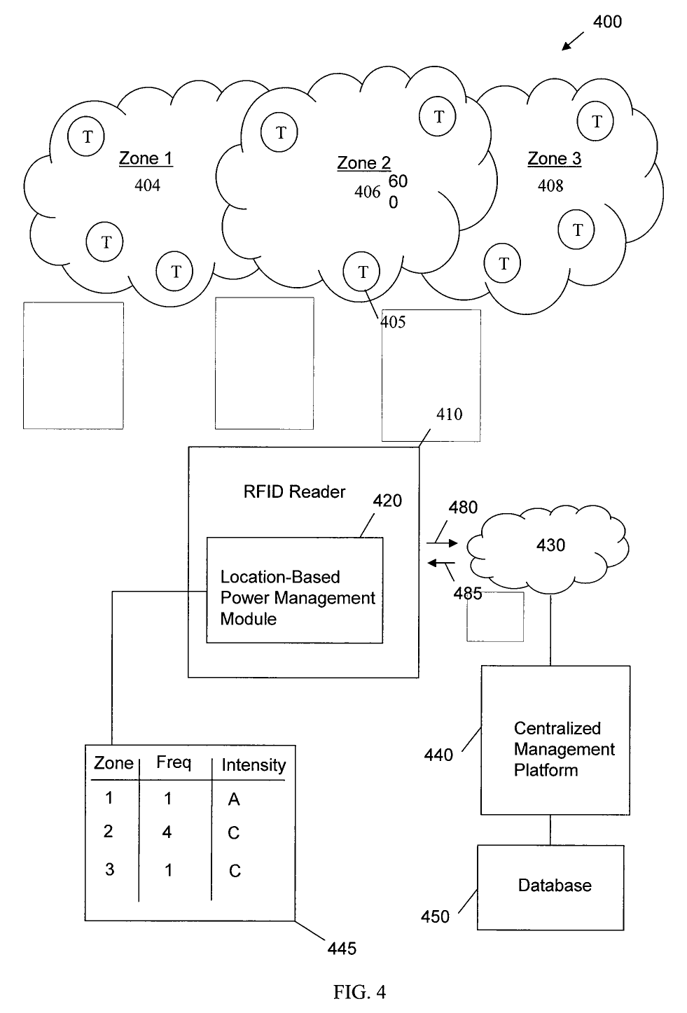

FIG. 4 shows an environment 400, in which the presence of items is monitored using RFID technology, according to an embodiment of the present invention. Environment 400 includes a zone 1 404, a zone 2 406, and a zone 3 408. An RFID reader 410 communicates with tags within environment 400.

RFID reader 410 includes an optional location-based power management module 420. Location-based power management module 420 may be used to adjust scanning settings of reader 410 based on location information.

Location-based power management module 420 may interact with data 445 stored locally at RFID reader 410 to determine scanning settings or characteristics to be applied for a particular location. Data 445 may include information related to the scanning settings of RFID reader 410. For example, data 445 may include the current scanning settings for RFID reader 410. In a further embodiment, data 445 includes information that can be used by location-based power management module 420 to map a current location of RFID reader 410 to scanning settings. For example, as shown in FIG. 4, data 445 includes a table that specifies a scanning frequency and an intensity for each of zone 1 404, zone 2 406, and zone 3 408. In a further embodiment, data 445 may be updated by reader 410. For example, reader 410 may determine that it has scanned zone 2 406 a relatively large number of times, compared to other zones (e.g., zone 1 404 and zone 3 408) and reader 410 may update data 445 to decrease the scanning frequency in zone 2 406.

In an embodiment, determining the location of a reader in an RFID environment may be accomplished by using landmark tags. Landmark tags are tags that are placed in fixed locations within an RFID environment. When a landmark tag of a population of landmark tags is interrogated, the landmark tag responds by backscattering a response to the reader. An identification code received in the response may identify the landmark tag to reader. The identification code of the landmark tag may be used to find the location of the landmark tag, and the location of the mobile device. By including landmark tags throughout an area, a mobile device may locate itself within the area by periodically interrogating one or more landmark tags.

In a further embodiment, data 445 also includes identification codes of landmark tags. In such an embodiment, location-based power management module 420 may be configured to interact with data 445 to map a received identification code directly to scanning settings.

In an alternate embodiment, a reader may determine its location using characteristics of the wireless network (such as a Wi-Fi network). For example, mobile devices within a wireless network may be able to estimate their location by using well-known methods, as would be understood by persons skilled in the relevant art(s). In a further embodiment, a reader may determine its location using Global Positioning System technology.

For more information regarding determining the location of a reader using tag data in RFID environments, refer to U.S. Ser. No. 10/909,252, filed Jul. 29, 2004, titled, “Mobile Terminal Finding System and Method,” now pending, which is incorporated by reference herein in its entirety.

Data 445 may be updated by centralized management platform 440. Reader 410 may interact with a centralized management platform 440 through a wireless network 430 to update data 445. In this embodiment, reader 410 may communicate contents of data 445 to centralized management platform 440 via one or more messages 480. Centralized management platform 440 responds with updates to be made to data 445 in one or more messages 485. Wireless network 430 may be a Wi-Fi wireless network, cellular network, or any other wireless network, as would be understood by persons skilled in the relevant art(s). In a further embodiment, database 450 stores scanning settings that can be updated by a user at centralized management platform 440. Centralized management platform 440 may retrieve updated scanning settings from database 450 and transmit those settings to RFID reader 410.

For example, a user may determine that items of high importance have been added in zone 3 408. Accordingly, the user may update database 450 with new scanning settings. The new scanning settings are then retrieved and transmitted to RFID reader 410 by centralized management platform 440.

In an illustrative example, reader 410 is integrated with a forklift in an “intelligent” warehouse that monitors the presence of items in zones 404-408. In such an embodiment, zones 404-408 may be aisles in a warehouse. Through analysis of prior scan information, for example contained in data 445 or stored in database 450 and received from centralized management platform 440, reader 410 may recognize it has visited zone 404 a relatively high number of times. In response, a scanning setting is changed so that when reader 410 is in zone 1 404, the frequency of scanning, or equivalently the duty cycle, is lowered. Alternatively, data may indicate that zone 406 is passed through less frequently. In response, the scanning frequency for zone 2 406 may be increased because information from zone 406 has greater likelihood of being stale.

In alternate embodiments, reader 410 or centralized management platform 440 may change scanning characteristics of a particular zone of zones 404-408 based on a variety of factors or may keep scanning settings constant.

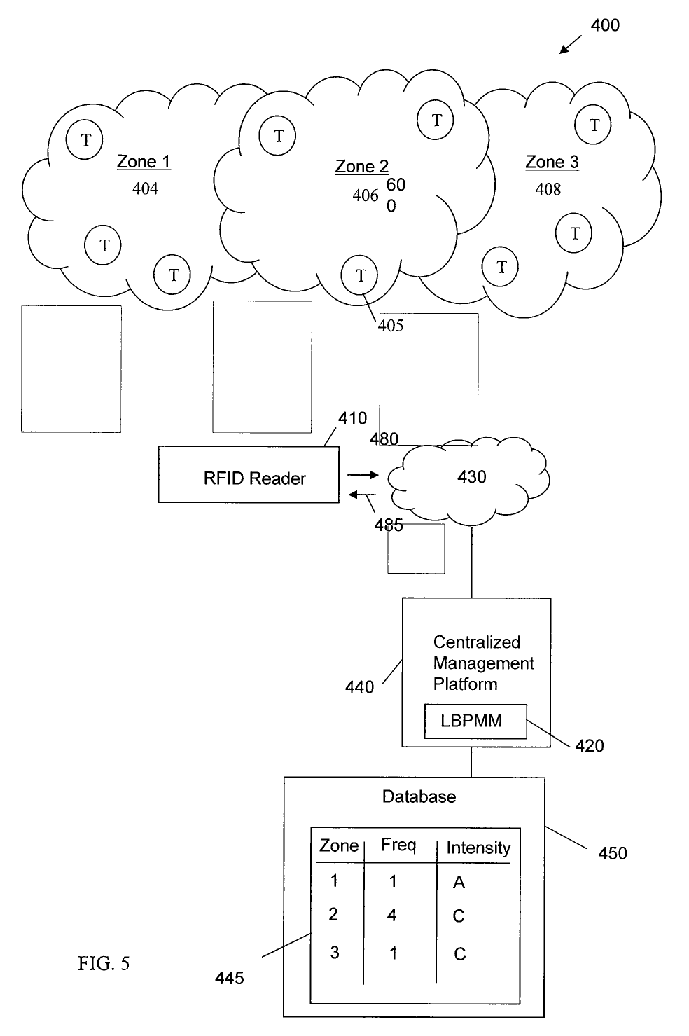

FIG. 5 shows another embodiment of environment 400, in which the presence of items is monitored using RFID technology, according to an embodiment of the present invention. The embodiment of FIG. 5 is generally similar to the embodiment of FIG. 4. However, in FIG. 5, location-based power management module 420 is located in centralized management platform 440 instead of in reader 410 as shown in FIG. 4. Furthermore, data 445 is stored within database 450 instead of at reader 410.

In FIG. 5, scanning settings are communicated to reader 410 from centralized management platform 440. For example, reader 410 may transmit its location to centralized management platform 440 through one or more messages 480. For example, reader 410 may determine its location through the use of landmark tags, as described above. Centralized management platform 440 responds with scanning settings in one or more messages 485. In particular, location-based power management module 420 interacts with data 445 stored in database 450 to map the received location to scanning settings.

Centralized management platform 440 may update data 445 stored in database 450. For example, data 445 may be updated based on the frequency of visits to a location and/or an importance of items present at a location.

Thus, scanning settings used by reader 410 can be adjusted based on the location of reader 410. For example, the scanning settings of reader 410 may be adjusted to lower a scanning frequency and/or a scanning intensity in certain areas. In such an embodiment, power may be saved because of the reduced scanning frequency and/or scanning intensity. In a further embodiment, reducing the scanning frequency and/or the scanning intensity may also result in improved spectrum management. For example, reducing the scanning frequency of reader 410 may reduce the amount of time reader 410 spends scanning. Furthermore, reducing the scanning frequency and/or scanning intensity also reduces the power with which interrogations may be conducted. Thus, the amount of time reader 410 emits RF radiation in one or more frequency bands and the amount of power emitted by reader 410 into the frequency band(s) may be reduced. The reduction in the amount of time during which RF radiation is emitted and the amount of power emitted may result in a reduced interference with other devices or systems that transmit or receive RF radiation in the frequency band(s).

In an embodiment, information regarding items or types of items that are expected in a location may be stored. Stored information regarding expected items or types of items may used to determine whether unexpected items are present in a location and/or whether expected items are missing from a location. For example, in FIG. 4, reader 410 may determine that it has entered zone 2 406 (e.g., through an interrogation of a landmark tag). Reader 410 interrogates tags in zone 2 406 and receives identification codes. The received identification codes along with the present location of reader 410 are transmitted to centralized management platform 440 via wireless network 430. Centralized management platform 440 interacts with database 450 to retrieve a list of identification codes that are expected to be received in zone 2 406. Upon comparing the received identification codes to the retrieved list of identification codes, centralized management platform 440 may determine that a received identification code is not on the retrieved list, and therefore the tag (and an item to which the tag may be affixed to) corresponding to that identification code is not expected to be in zone 2 406. In an embodiment, the item to which the tag is affixed may be considered misplaced. In response, centralized management platform 440 may transmit updated scanning settings that increase a scanning frequency or intensity so that information regarding other misplaced items in zone 2 406 may be determined. In alternate embodiments, reader 410 may locally store a list of tags expected in each zone and/or scanning settings to be used when a misplaced item is found.

In the embodiment of FIG. 5, a similar determination regarding a misplaced item may be made. However, in FIG. 5, the location of reader 410 is determined by centralized management platform 440. Thus, reader 410 may only need to transmit identification codes that are received, and not its present location, to centralized management platform 440 for a determination regarding misplaced items to be made.

A determination regarding a tag that is missing from a particular zone may be made in a similar manner. For example, received identification codes may be compared with a list of expected identification codes and an identification code that is present in the retrieved list, but missing from the received identification codes may be considered missing.

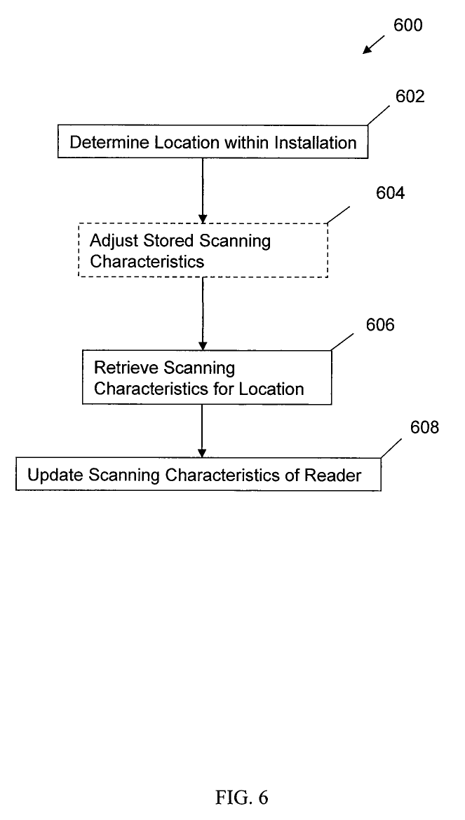

FIG. 6 shows a flowchart 600 of a method for reducing power consumption in readers through application of location information, according to an embodiment of the present invention. Flowchart 600 is described with reference to the embodiments of FIGS. 4 and 5. However flowchart 600 is not limited to those embodiments. The steps shown in FIG. 6 do not necessarily have to occur in the order shown. The steps of FIG. 6 are described in detail below.

Flowchart 600 begins with step 602. In step 602, a determination of the reader's location within an installation is made. For example, in FIG. 4, reader 410 determines its location within environment 400. In an alternate embodiment, centralized management platform 440 may determine the location of reader 410. As described above, a variety of techniques may be used by reader 410 and/or centralized management platform 440 to determine the location of reader 410.

In optional step 604, stored scanning characteristics are adjusted. For example, in FIG. 4, reader 410 may determine that it has visited zone 2 406 a relatively high number of times and may accordingly decrease the values for the scanning frequency and/or intensity contained in data 445. In a further embodiment, reader 410 updates scanning settings is real-time as it is performing a scan. Additionally or alternatively, stored scanning characteristics may be updated in other ways. For example, in FIG. 5, a user located at centralized management platform 440 may determine that an item of high importance has recently been placed in zone 2 406. Accordingly, data 445 stored in database 450 may be updated to increase the scanning frequency and/or intensity of reader 410 in zone 2 406. Centralized management platform 440 then may retrieve the updated settings and communicate them to RFID reader 410.

In step 606, the scanning characteristics associated with the determined location are retrieved. For example, each zone of a wireless installation may be associated with a set of scanning characteristics. Scanning characteristics include, but are not limited to frequency of scanning and intensity of a scan. For example, in FIG. 4, location-based power management module 420 may retrieve scanning characteristics from data 445 stored locally on reader 410.

In an alternate embodiment, scanning characteristics are determined by centralized management platform 440 and communicated to reader 410 through wireless network 430. For example, in FIG. 5, centralized management platform 440 may include location-based power management module 420 that interacts with data 445 stored in database 450 to map a received location of RFID reader 410 to scanning characteristics. The scanning characteristics are then communicated to RFID reader 410 through messages 485 over wireless network 430.

In step 608, scanning characteristics for the reader are updated. For example, in FIG. 4, having determined its location to be zone 2 406 and retrieving corresponding scanning characteristics for zone 2 406, reader 410 updates its scanning settings according to the retrieved scanning characteristics. Alternatively, in FIG. 5, reader 410 may update its scanning characteristics based on scanning characteristics received from centralized management platform 440.

Thus, location awareness effectively allows for the mapping of a location to corresponding scanning settings. In this way, a reader may lower scanning frequency and intensity in certain locations, thereby conserving power.

The present invention (i.e., elements of FIGS. 4 and 5 and flowchart 600 or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

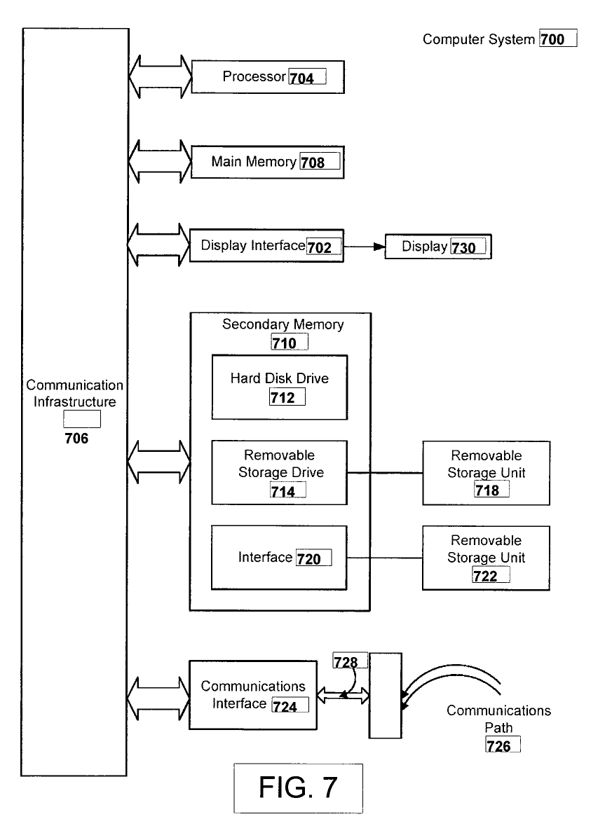

In fact, in one embodiment, the invention is directed toward one or more computer systems capable of carrying out the functionality described herein. An example of a computer system 700 is shown in FIG. 7.

The computer system 700 includes one or more processors, such as processor 704. The processor 704 is connected to a communication infrastructure 706 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 700 can include a display interface 702 that forwards graphics, text, and other data from the communication infrastructure 706 (or from a frame buffer not shown) for display on the display unit 730.

Computer system 700 also includes a main memory 708, preferably random access memory (RAM), and may also include a secondary memory 710. The secondary memory 710 may include, for example, a hard disk drive 712 and/or a removable storage drive 714, representing a floppy disk drive, a magnetic tape drive, an optical disk drive, etc. The removable storage drive 714 reads from and/or writes to a removable storage unit 718 in a well known manner. Removable storage unit 718 represents a floppy disk, magnetic tape, optical disk, etc. which is read by and written to by removable storage drive 714. As will be appreciated, the removable storage unit 718 includes a computer usable storage medium having stored therein computer software and/or data.

In alternative embodiments, secondary memory 710 may include other similar devices for allowing computer programs or other instructions to be loaded into computer system 700. Such devices may include, for example, a removable storage unit 722 and an interface 720. Examples of such may include a program cartridge and cartridge interface (such as that found in video game devices), a removable memory chip (such as an erasable programmable read only memory (EPROM), or programmable read only memory (PROM)) and associated socket, and other removable storage units 722 and interfaces 720, which allow software and data to be transferred from the removable storage unit 722 to computer system 700.

Computer system 700 may also include a communications interface 724. Communications interface 724 allows software and data to be transferred between computer system 700 and external devices. Examples of communications interface 724 may include a modem, a network interface (such as an Ethernet card), a communications port, a Personal Computer Memory Card International Association (PCMCIA) slot and card, etc. Software and data transferred via communications interface 724 are in the form of signals 728 which may be electronic, electromagnetic, optical or other signals capable of being received by communications interface 724. These signals 728 are provided to communications interface 724 via a communications path (e.g., channel) 726. This channel 726 carries signals 728 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 714 and a hard disk installed in hard disk drive 712. These computer program products provide software to computer system 700. The invention is directed to such computer program products.

Computer programs (also referred to as computer control logic) are stored in main memory 708 and/or secondary memory 710. Computer programs may also be received via communications interface 724. Such computer programs, when executed, enable the computer system 700 to perform the features of the present invention, as discussed herein. In particular, the computer programs, when executed, enable the processor 704 to perform the features of the present invention. Accordingly, such computer programs represent controllers of the computer system 700.

In an embodiment where the invention is implemented using software, the software may be stored in a computer program product and loaded into computer system 700 using removable storage drive 714, hard drive 712 or communications interface 724. The control logic (software), when executed by the processor 704, causes the processor 704 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of managing power consumption in a radio frequency identification (RFID) reader, comprising:
determining a present location of the RFID reader;
retrieving scanning characteristics for the determined location; and
updating scanning settings of the RFID reader based on the retrieved scanning characteristics.

2. The method of claim 1, wherein determining the location comprises:
interrogating a fixed RFID tag; and
determining the location of the mobile reader based at least on an identification code received during the interrogating step.

3. The method of claim 1, wherein determining the location comprises:
determining the location of the RFID reader based on a Global Positioning System (GPS) data.

4. The method of claim 1, wherein determining the location comprises:
determining the location of the RFID reader based information available in the wireless protocol.

5. The method of claim 1, further comprising:
setting the scanning characteristics for the location based on data gathered from prior interrogations of the location.

6. The method of claim 5, wherein data gathered includes at least one of a density of RFID tags of the location, a frequency of historical visits to the location, and a number of past visits to the location.

7. The method of claim 1, further comprising:
setting the scanning characteristics for the location based on an importance of the location.

8. The method of claim 1, further comprising:
updating the scanning characteristics in real-time.

9. The method of claim 1, wherein the updating step comprises:
adjusting a scanning frequency of the RFID reader.

10. The method of claim 1, wherein the updating step comprises:
adjusting a scanning intensity of the RFID reader.

11. The method of claim 1, whereby interference with other readers is reduced.

12. A computer program product comprising a computer useable medium including control logic stored therein, said control logic when executed enabling a processor to manage power consumption in a radio frequency identification (RFID) reader, said control logic comprising:
determining means for enabling a processor to determine a present location of the RFID reader;
retrieving means for enabling a processor to retrieve scanning characteristics for the determined location; and
updating means for enabling a processor to update scanning settings of the RFID reader based on the retrieved scanning characteristics.

13. The computer program product of claim 12, wherein the determining means comprises:
interrogating means for enabling a processor to interrogate a fixed RFID tag; and
determining means for enabling a processor to determine the location of the mobile reader based at least on an identification code received during an interrogation of the fixed RFID tag.

14. The computer program product of claim 12, wherein the determining means comprises:
determining means for enabling a processor to determine the location based on Global Positioning System (GPS) data or information available in the wireless protocol.

15. The computer program product of claim 12, further comprising:
setting means for enabling a processor to set the scanning characteristics for the location based on data gathered from prior interrogations of the location or an importance of the location.

16. The computer program product of claim 12, wherein the updating means comprises:
adjusting means for enabling a processor to adjust a scanning frequency or intensity of the RFID reader.

17. A mobile radio frequency identification (RFID) reader, comprising:
means for determining a present location of the RFID reader;
means for retrieving scanning characteristics for the determined location; and
means for updating scanning settings of the RFID reader based on the retrieved scanning characteristics.

18. The mobile RFID reader of claim 17, wherein means for determining comprises:
means for interrogating a fixed RFID tag; and
means for determining the location of the mobile reader based at least on an identification code received through an interrogation of the fixed RFID tag.

19. The mobile RFID reader of claim 17, wherein means for determining comprises:
means for determining the location based on Global Positioning System (GPS) data or information available in the wireless protocol.

20. The mobile RFID reader of claim 17, further comprising:
means for setting the scanning characteristics based on data gathered from prior interrogations of the location or an importance of the location.

21. The mobile RFID reader of claim 17, wherein means for updating comprises:
means for adjusting a scanning frequency or intensity of the RFID reader.
